(19) United States
(12) Patent Application Publication
(10) Pub. No.: US 2026/0063481 A1
(43) Pub. Date: Mar. 5, 2026

(54) PROBE SUPPORTS, PROBE ASSEMBLIES THAT INCLUDE THE PROBE SUPPORTS, PROBE SYSTEMS THAT INCLUDE THE PROBE ASSEMBLIES, AND RELATED METHODS

(71) Applicant: FormFactor, Inc., Livermore, CA (US)

(72) Inventors: Masahiro Sameshima, Tokyo (JP); Yoichi Funatoko, Tokyo (JP); Gavin Neil Fisher, Fenny Compton (GB)

(21) Appl. No.: 19/291,351

(22) Filed: Aug. 5, 2025

Related U.S. Application Data
(60) Provisional application No. 63/688,600, filed on Aug. 29, 2024.

(51) Int. Cl. G01L 1/22

(52) U.S. Cl. CPC G01L 1/2287; G01L 1/2218; G01L 1/2262

(57) ABSTRACT

Probe supports, probe assemblies that include the probe supports, probe systems that include the probe assemblies, and related methods. The probe assemblies include the probe support, a probe support mounting structure, and a probe. The probe support may include an elongate support body that extends between a support mount and a probe mount. The probe support also may include a deformation measurement structure configured to generate a deformation output indicative of deformation of the elongate support body. The probe support mounting structure may be operatively attached to the support mount. The probe may be operatively attached to the probe mount. The probe systems include a chuck, a signal generation and analysis assembly, and the probe assembly. The methods control the operation of a probe system based, at least in part, on a deformation output.

### RELATED APPLICATION

This application claims priority to U.S. Provisional Patent Application No. 63/688,600, which was filed on Aug. 29, 2024, and the complete disclosure of which is hereby incorporated by reference.

### FIELD OF THE DISCLOSURE

The present disclosure relates generally to probe supports, to probe assemblies that include the probe supports, to probe systems that include the probe assemblies, and to related methods.

### BACKGROUND OF THE DISCLOSURE

Probe systems may be utilized to test the operation of one or more devices under test (DUTs) formed on a substrate. In some probe systems, probes, such as electrical probes, conventionally are utilized to contact, to physically contact, and/or to electrically contact the DUT, such as to permit and/or facilitate supply of an electric test signal to the DUT and/or receipt of an electric resultant signal from the DUT. Historically, optical microscopes have been utilized to visually observe the probes and/or the DUTs, such as to facilitate alignment between the probes and the DUTs and/or to observe contact between the probes and the DUTs. However, as DUTs become progressively smaller and/or as a density of circuits on the DUTs increases, it becomes increasingly challenging to reliably establish contact between the probes and the DUTs. As an example, a resolution at which the optical microscopes may be utilized to observe and/or quantify contact between the probes and the DUTs may be limited by a resolution of the optical microscopes and/or by a depth-of-focus of the optical microscopes. In state-of-the-art probe systems, it may be desirable, or even necessary, to monitor contact and/or overdrive between the probes and the DUTs at a resolution that exceeds the capabilities of conventional optical microscopes. Thus, there exists a need for improved probe assemblies of a probe system and for related methods.

### SUMMARY OF THE DISCLOSURE

Probe supports, probe assemblies that include the probe supports, probe systems that include the probe assemblies, and related methods are disclosed herein. The probe assemblies include the probe support, a probe support mounting structure, and a probe. The probe support may include an elongate support body that extends between a support mount and a probe mount. The probe support also may include a deformation measurement structure configured to generate a deformation output indicative of deformation of the elongate support body. The probe support mounting structure may be operatively attached to the support mount. The probe may be operatively attached to the probe mount.

The probe systems include a chuck, a signal generation and analysis assembly, and the probe assembly. The chuck may define a support surface configured to support a substrate that includes a device under test (DUT). The probe assembly may be positioned to permit the probe to selectively contact the DUT. The signal generation and analysis assembly may be configured to at least one of provide an electric test signal to the DUT via the probe and receive an electric resultant signal from the DUT via the probe.

The methods are methods of controlling the operation of a probe system and include changing a relative orientation, monitoring a deformation output, and regulating the changing. The changing the relative orientation may include changing a relative orientation between a support surface of the probe system and a probe assembly of the probe system. The monitoring the deformation output may include monitoring a deformation output of a deformation measurement structure of the probe system. The deformation output may be indicative of deformation of an elongate support body that is operatively attached to a probe of the probe system. The monitoring the deformation output may be performed during the changing the relative orientation. The regulating the changing may include regulating the changing the relative orientation based, at least in part, on the deformation output.

### BRIEF DESCRIPTION OF THE DRAWINGS

FIG. 1 is a schematic illustration of examples of a probe support that may be included in a probe assembly of a probe system, of probe assemblies, and of probe systems, according to the present disclosure.

FIG. 2 is a schematic illustration of an example of a probe support, according to the present disclosure.

FIG. 3 is a schematic illustration of an example of a deformation measurement structure of a probe support, according to the present disclosure.

FIG. 4 is a plot illustrating an example of a representation of deformation output from a deformation measurement structure of a probe support, according to the present disclosure.

FIG. 5 is a flowchart illustrating examples of methods of controlling operation of a probe system, according to the present disclosure.

FIG. 6 is a plot illustrating an example of a surface map that may be generated utilizing a probe support, according to the present disclosure.

### DETAILED DESCRIPTION AND BEST MODE OF THE DISCLOSURE

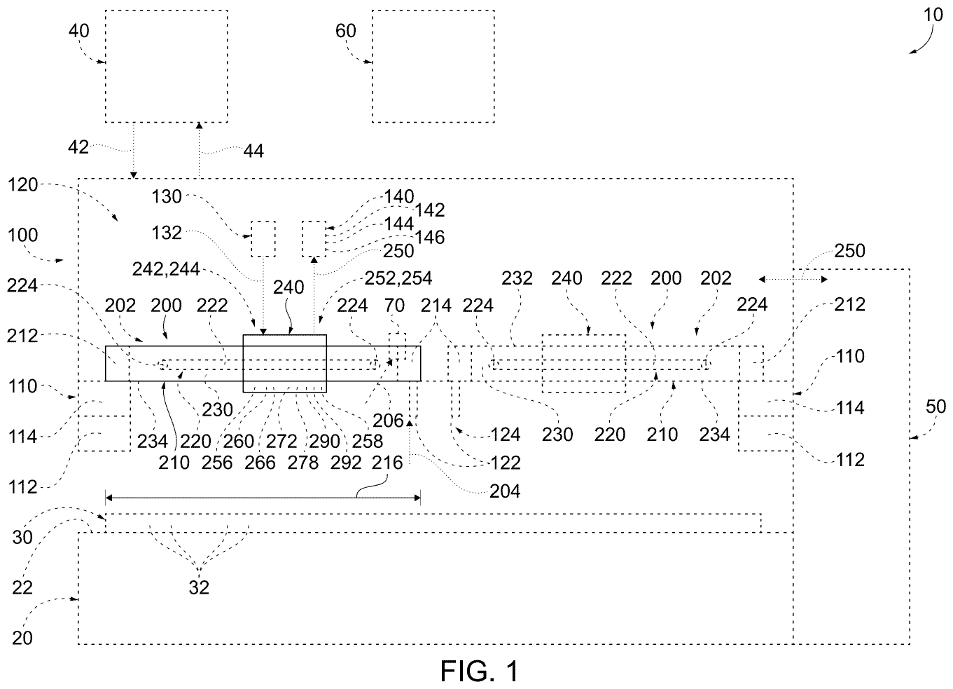

FIGS. 1-6 provide examples of probe systems 10, probe assemblies 100, probe supports 200, methods 300, and/or of data generated utilizing probe systems 10, probe assemblies 100, probe supports 200, and/or methods 300, according to the present disclosure. Elements that serve a similar, or at least substantially similar, purpose are labeled with like numbers in each of FIGS. 1-6, and these elements may not be discussed in detail herein with reference to each of FIGS. 1-6. Similarly, all elements may not be labeled in each of FIGS. 1-6, but reference numerals associated therewith may be utilized herein for consistency. Elements, components, and/or features that are discussed herein with reference to one or more of FIGS. 1-6 may be included in and/or utilized with any of FIGS. 1-6 without departing from the scope of the present disclosure.

In general, elements that are likely to be included in a particular embodiment are illustrated in solid lines in FIGS. 1-3 and 5, while elements that may be optional are illustrated in dashed lines. However, elements that are shown in solid lines may not be essential to all embodiments and, in some embodiments, may be omitted without departing from the scope of the present disclosure.

FIG. 1 is a schematic illustration of examples of a probe support 200 that may be included in a probe assembly 100 of a probe system 10, according to the present disclosure. Probe supports 200 include an elongate support body 210 that extends between a support mount 212 and a probe mount 214. Support mount 212 is configured to operatively attach probe support 200 to a remainder of probe system 10. Probe mount 214 is configured to operatively attach a probe 122 to the elongate support body. Probe support 200 also includes a deformation measurement structure 240, which is configured to generate a deformation output 250 that is indicative of deformation of elongate support body 210.

Probe assemblies 100 include a probe support mounting structure 110, probe 122, and probe support 200. Support mount 212 is operatively attached to probe support mounting structure 110, and probe 122 is operatively attached to probe mount 214.

Probe systems 10 include a chuck 20 that defines a support surface 22. Support surface 22 may be configured to support a substrate 30 that includes one or more devices under test (DUTs) 32. Examples of the substrate include a wafer, a semiconductor wafer, a silicon wafer, and/or a type III-V semiconductor wafer. Examples of the DUT include a solid state device, a semiconductor device, an electronic device, and/or an optoelectronic device.

Probe systems 10 also include probe assembly 100, which is positioned to permit and/or facilitate contact, physical contact, electrical contact, and/or electrically conductive contact between at least one probe 122 thereof and DUT 32. Probe systems 10 further include a signal generation and analysis assembly 40. The signal generation and analysis assembly is configured to provide an electric test signal 42 to the DUT via the probe and/or to receive an electric resultant signal 44 from the DUT via the probe.

Examples of chuck 20 include a thermal chuck, a temperature-controlled chuck, a vacuum chuck, and/or an electrically shielded chuck. Examples of signal generation and analysis assembly 40 include a power supply, an AC power supply, a DC power supply, a function generator, a signal generator, a signal analyzer, and/or an impedance analyzer.

During operative use of probe systems 10 to test, or to electrically test, DUTs 32, a force 204 may be applied to probe support 200, such as via, at, and/or near probe mount 214 thereof. This may be accomplished in any suitable manner. As an example, probe 122 may be brought into contact with DUT 32, such as via moving probe assembly 100 downward and/or moving chuck 20 upward from the relative orientation that is illustrated in FIG. 1. In such a configuration, at least a fraction of a contact force between the probe and the DUT may be transferred to probe support 200 as force 204. Also in such a configuration, and as discussed in more detail herein, deformation output 250 may be utilized to determine and/or establish when contact between the probe and the DUT occurs, may be utilized to determine and/or establish a magnitude of the contact force between the probe and the DUT, and/or may be utilized to determine and/or establish a magnitude of overdrive between the probe and the DUT.

As used herein, the term “overdrive” refers to a magnitude of relative motion between the probe and the DUT toward one another subsequent to physical contact between the probe and the DUT. Stated differently, overdrive may refer to a magnitude of deflection of probe 122 and/or probe mount 214, such as may be relative to support mount 212, that results from the contact force between the probe and the DUT. Overdrive may be utilized to maintain reliable contact between the probe and the DUT and/or to establish a desired magnitude of the contact force between the probe and the DUT.

As another example, and during lateral motion of probe 122 relative to DUT 32 and/or relative to support surface 22, a portion of probe assembly 100, such as probe 122, probe support 200, and/or elongate support body 210, may contact, or may inadvertently contact, another object 70, thereby applying a force 206 to the probe support. Examples of object 70 include substrate 30, DUT 32, another probe assembly 100, a component of another probe assembly 100, and/or another component of probe systems 10, and/or foreign material and/or debris that unexpectedly may be present within probe systems 10.

Force 206 also may be referred to herein as a lateral force 206. In such a configuration, and as discussed in more detail herein, detection of deformation output 250, or of a change in the deformation output, may be utilized to detect the inadvertent contact. Thus, the lateral motion may be ceased and/or stopped responsive to detection of the deformation output, such as to prevent and/or decrease a potential for damage to one or more components of probe system 10 due to the inadvertent contact.

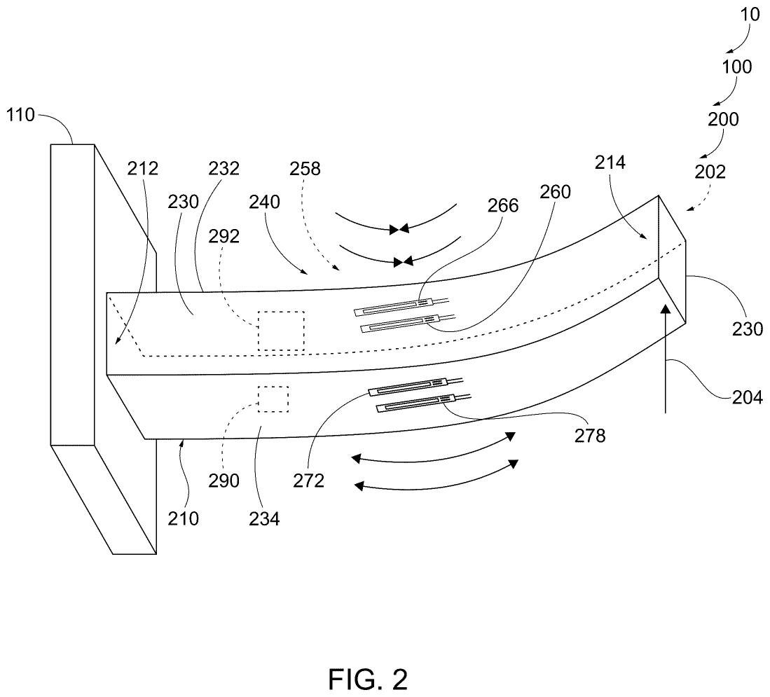

Probe supports 200 may include any suitable structure that includes elongate support body 210 and deformation measurement structure 240. FIG. 2 is a less schematic illustration of an example of a probe support 200, such as in the form of an elongate beam, that is being deformed due to application of a force 204, according to the present disclosure. Similarly, elongate support body 210 may include and/or may be defined by any suitable body material. As examples, elongate support body 210 may include and/or be defined by a resilient body material, a metallic body material, aluminum, an aluminum alloy, steel, and/or a stainless steel alloy.

Elongate support body 210 may define a support body aspect ratio, such as may be a ratio of a longitudinal length, or maximum dimension, of the elongate support body to a transverse dimension, or a maximum transverse dimension, of the elongate support body. Stated differently, the transverse dimension may be measured within a plane that is perpendicular to the longitudinal length and/or to the maximum dimension. Examples of the support body aspect ratio include at least 4:1, at least 6:1, at least 8:1, at least 10:1, at least 12:1, at most 30:1, at most 25:1, at most 20:1, at most 15:1, and/or at most 10:1.

The elongate support body may have and/or define any suitable shape, or external shape. As examples, the elongate support body may be rectangular, at least substantially rectangular, and/or at least partially rectangular. Additionally or alternatively, the elongate support body may be a rectangular solid, an at least substantially rectangular solid, and/or an at least partially rectangular solid.

As illustrated in dashed lines in FIG. 1, elongate support body 210 may have and/or define an elongate opening 220. Elongate opening 220 may extend at least partially between support mount 212 and probe mount 214. Such a configuration may permit and/or facilitate selective variation of a rigidity of elongate support body 210, and/or of a rigidity of the elongate support body as measured in different dimensions and/or directions, such as may be based upon a size, position, orientation, and/or shape of the elongate opening.

Elongate opening 220 may extend along a threshold opening fraction of a support body length 216 of elongate support body 210. Examples of the threshold opening fraction include at least 10%, at least 20%, at least 30%, at least 40%, at least 50%, at least 60%, at least 70%, at least 80%, at most 90%, at most 80%, at most 70%, at most 60%, at most 50%, and/or at most 40%. Elongate opening 220 may have and/or define any suitable shape. As examples, the elongate opening may be a rectangular, an at least substantially rectangular, and/or an at least partially rectangular elongate opening, as indicated in FIG. 1 at 222. As additional examples, the elongate opening may include cylindrical, or at least partially cylindrical, opening end regions, as indicated at 224. As further examples, the elongate opening may be polygonal, ovoid, trapezoidal, and/or squircular.

In some examples, elongate support body 210 may define an upper body surface 232, a lower body surface 234, and/or a pair of opposed side body surfaces 230. In such a configuration, elongate opening 220 may extend at least partially, or even completely, from and/or between the pair of opposed side body surfaces. Additionally or alternatively, elongate opening 220 may extend parallel, or at least substantially parallel, to upper body surface 232 and/or to lower body surface 234.

Support mount 212 may include and/or be any suitable structure that may be adapted, configured, designed, and/or constructed to operatively attach probe support 200 to the remainder of the probe system. Examples of support mount 212 include a support mount fastener, a support mount fastener-receiving region, and/or a support mount fastener-engaging region. Similarly, probe mount 214 may include any suitable structure that may be adapted, configured, designed, and/or constructed to operatively attach probe 122 to elongate support body 210. Examples of probe mount 214 include a probe mount fastener, a probe mount fastener-receiving region, and/or a probe mount fastener-engaging region.

Deformation measurement structure 240 may include any suitable structure that may be adapted, configured, designed, and/or constructed to generate deformation output 250 that is indicative of, generated responsive to, generated during, and/or proportionate to deformation of elongate support body 210. As an example, deformation measurement structure 240 may include and/or be a deformation measurement sensor 256, or a plurality of deformation measurement sensors 256. Examples of deformation measurement sensors 256 include a strain gauge, a ring gauge, a force sensor, and/or a piezoelectric sensor. In some examples, elongate support body 210 and deformation measurement structure 240 together may define a load cell 202, which may be configured to detect and/or measure forces applied to elongate support body 210 via detection of deformation of the elongate support body. In some examples, the plurality of deformation measurement sensors 256 may include a plurality of identical, or at least substantially identical, deformation measurement sensors. In some examples, the plurality of deformation measurement sensors may form and/or define a bridge circuit 258, as illustrated in FIGS. 1-3.

Deformation measurement structure 240 may be configured to measure deformation of elongate support body 210, to detect deformation of the elongate support body, and/or to generate the deformation output indicative of deformation of the elongate support body in any suitable manner. As an example, deformation measurement structure 240 may be configured to deform, to flex, to move, to exhibit a change in resistance, to exhibit a change in capacitance, and/or to exhibit a change in inductance during, responsive to, and/or proportionate to a magnitude of deformation of the elongate support body. As additional examples, the deformation measurement structure and/or deformation measurement sensors 256 thereof may be operatively attached to the elongate support body, may be adhered to the elongate support body, and/or may be in mechanical communication with the elongate support body.

In some examples, and as discussed, probe support 200 and/or deformation measurement structure 240 thereof may be adapted, configured, designed, and/or constructed to generate deformation output 250 responsive to deformation of elongate support body 210 that is generated by physical contact between probe 122 and DUT 32. Stated differently, the force that is applied to probe support 200 may be applied via probe 122, via probe mount 214, and/or in a direction that is parallel, or at least substantially parallel, to force 204 of FIGS. 1-2.

In some such examples, deformation measurement structure 240 may be operatively attached to, and/or may be in mechanical communication with, upper body surface 232, as indicated in FIGS. 1-2 at 260 and 266, and/or with lower body surface 234, as indicated in FIGS. 1-2 at 272 and 278. Stated differently, deformation measurement structure 240 may be configured to measure, and/or deformation output 250 may be indicative of, deformation of the upper body surface and/or of the lower body surface. This deformation may include extension, as indicated by diverging arrows near lower body surface 234 of FIG. 2, and/or contraction, as indicated by converging arrows near upper body surface 232 of FIG. 2. Additionally or alternatively, this deformation may include flexure, torsion, and/or rotation of the upper body surface and/or of the lower body surface.

In a specific example, deformation measurement structure 240 may include a pair of upper deformation measurement sensors 260, 266 operatively attached to upper body surface 232, and deformation measurement structure 240 further may include a pair of lower deformation measurement sensors 272, 278 operatively attached to lower body surface 234. The pair of upper deformation measurement sensors may include a first upper deformation measurement sensor 260 and a second upper deformation measurement sensor 266, and the pair of lower deformation measurement sensors may include a first lower deformation measurement sensor 272 and a second lower deformation measurement sensor 278, as illustrated in FIGS. 1-3.

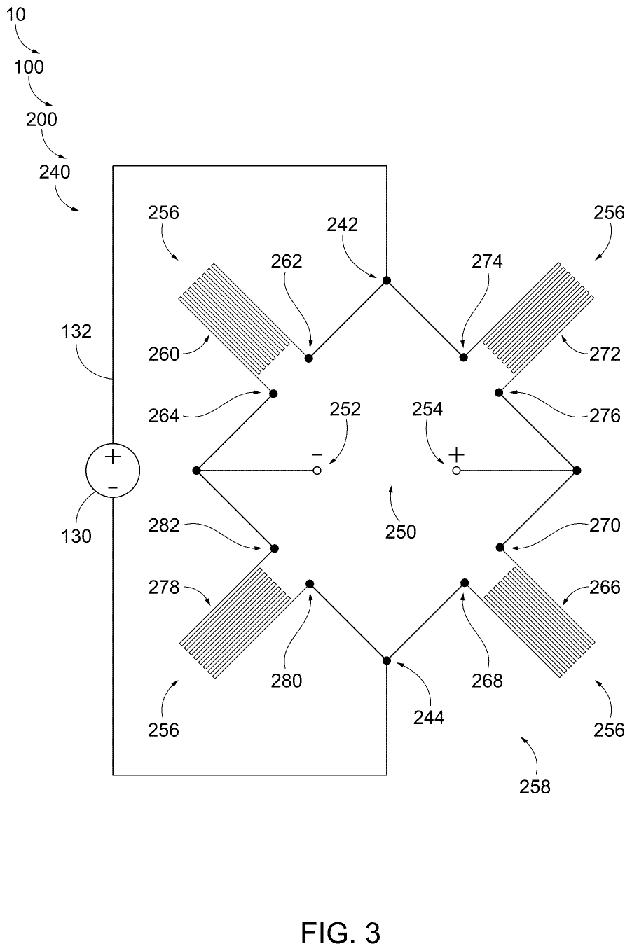

As illustrated in FIG. 3, first upper deformation measurement sensor 260 may include a first upper input 262 and a first upper output 264, and second upper deformation measurement sensor 266 may include a second upper input 268 and a second upper output 270. As also illustrated in FIG. 3, first lower deformation measurement sensor 272 may include a first lower input 274 and a first lower output 276, and second lower deformation measurement sensor 278 may include a second lower input 280 and a second lower output 282. First upper input 262 may be shorted, electrically shorted, shunted, and/or electrically connected to first lower input 274 to define a first input terminal 242 of the deformation measurement structure. Second upper input 268 may be shorted, electrically shorted, shunted, and/or electrically connected to second lower input 280 to define a second input terminal 244 of the deformation measurement structure. In addition, first upper output 264 may be shorted, electrically shorted, shunted, and/or electrically connected to second lower output 282 to define a first output terminal 252 of the deformation measurement structure; and second upper output 270 may be shorted, electrically shorted, shunted, and/or electrically connected to first lower output 276 to define a second output terminal 254 of the deformation measurement structure. Such a configuration also may be referred to herein as bridge circuit 258.

As perhaps best illustrated in FIG. 2, first upper deformation measurement sensor 260 may be positioned relatively proximate a corresponding side body surface 230 relative to second upper deformation measurement sensor 266. In addition, first lower deformation measurement sensor 272 may be positioned relatively proximate the other side body surface 230 relative to second lower deformation measurement sensor 278. In such a configuration, bridge circuit 258 may be balanced, or at least substantially balanced, when there is no deformation of elongate support body 210 and may be unbalanced, or relatively more unbalanced, when elongate support body 210 is deformed in a direction that is perpendicular, or at least substantially perpendicular, to upper body surface 232 and/or to lower body surface 234. As such, deformation measurement structure 240 may provide a high level of sensitivity to deformation of elongate support body 210, such as via variation in an electrical resistance of bridge circuit 258 with deformation of the elongate support body.

In some examples, and as illustrated in FIGS. 1 and 3, deformation measurement structure 240 may include an excitation voltage source 130. Excitation voltage source 130 may be configured to apply an excitation voltage differential 132 between first input terminal 242 and second input terminal 244, as perhaps best illustrated in FIG. 3. In such a configuration, deformation output 250 may include and/or be a deformation output voltage differential between first output terminal 252 and second output terminal 254.

In some examples, probe support 200 and/or deformation measurement structure 240 thereof may be adapted, configured, designed, and/or constructed to generate deformation output 250 responsive to physical contact between elongate support body 210 and the other object 70 during lateral motion of probe assembly 100. Such lateral motion may be in a plane that is parallel, or at least substantially parallel, to support surface 22. Stated differently, the force that is applied to probe support 200 (e.g., force 206 in FIG. 1) may be applied in a direction that is perpendicular, or at least substantially perpendicular, to force 204 of FIGS. 1-2.

In some such examples, deformation measurement structure 240 may be operatively attached to and/or may be in mechanical communication with at least one, or both, side body surfaces 230 of elongate support body 210. Stated differently, deformation measurement structure 240 may be configured to measure, and/or deformation output 250 may be indicative of, deformation of side body surfaces 230. In a specific example, and as illustrated in FIGS. 1-2, deformation measurement structure 240 may include a first pair of lateral deformation measurement sensors 290, which is operatively attached to a first side body surface of the pair of opposed side body surfaces 230, and a second pair of lateral deformation measurement sensors 292, which is operatively attached to a second side body surface of the pair of opposed side body surfaces 230. The first pair of lateral deformation measurement sensors and the second pair of lateral deformation measurement sensors may be positioned and/or electrically interconnected in a manner that is at least substantially similar to first upper deformation measurement sensor 260, second upper deformation measurement sensor 266, first lower deformation measurement sensor 272, and second lower deformation measurement sensor 278. Stated differently, the first pair of lateral deformation measurement sensors and the second pair of lateral deformation measurement sensors may form a corresponding bridge circuit, such as in a manner that is discussed herein with reference to FIG. 3.

Returning more specifically to FIG. 1, but with general reference to FIGS. 2-3, probe systems 10 may include a motion control assembly 50, which may be adapted, configured, designed, and/or constructed to selectively regulate a relative orientation between support surface 22 (and/or DUT 32) and probe assembly 100, such as to permit and/or facilitate contact between probe 122 and DUT 32. Examples of motion control assembly 50 include an actuator, a linear actuator, a rotary actuator, a linear motor, a rack and pinion assembly, a lead screw and nut assembly, a ball screw and nut assembly, a motor, a servo motor, a stepper motor, and/or a piezoelectric actuator.

Motion control assembly 50 may be configured and/or programmed to receive deformation output 250, or another signal that is based upon and/or representative of the deformation output, from probe assembly 100. Additionally or alternatively, motion control assembly 50 may be configured to control the operation of probe system 10 and/or to regulate relative motion between support surface 22 and probe assembly 100 based, at least in part, on the deformation output. This may include controlling the operation and/or regulating the relative motion by performing any suitable step and/or steps of methods 300, which are discussed in more detail herein.

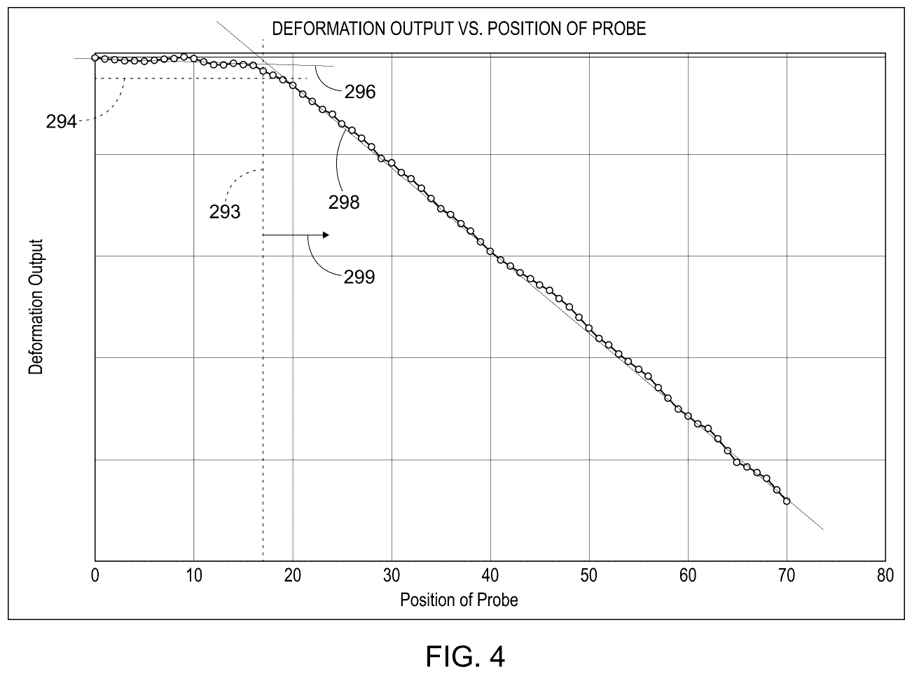

As an example, motion control assembly 50 may be programmed and/or configured to determine and/or indicate contact, physical contact, electrical contact, and/or electrically conductive contact between probe 122 and DUT 32 based, at least in part, on deformation output 250. As a more specific example, and with reference to FIG. 4, contact 293 between the probe and the DUT may be determined and/or indicated when and/or responsive to the deformation output changing by more than a threshold deformation output contact change during relative motion of the probe and/or the DUT toward one another, as indicated at 294. As another example, contact between the probe and the DUT may be determined and/or indicated when and/or responsive to a slope of the deformation output as a function of position of the probe changing from a first slope 296 to a second slope 298.

As another example, motion control assembly 50 may be programmed and/or configured to regulate overdrive between the probe and the DUT based, at least in part, on the deformation output. As a more specific example, and with reference to FIG. 4, subsequent to determining and/or indicating contact 293 between the probe and the DUT, motion control assembly 50 may be configured to provide target and/or desired amount of overdrive 299 between the probe and the DUT, with this overdrive 299 being determined and/or quantified based, at least in part, on the deformation output. As another more specific example, and during testing of the DUT by the probe system, overdrive 299 may be maintained at the target and/or desired overdrive, such as via adjusting the position of the probe relative to the DUT to maintain a specified deformation output and/or to maintain the deformation output within a specified deformation output range. Such a configuration may be utilized to maintain a constant, or at least substantially constant, contact force between the probe and the DUT during testing of the DUT, which may improve and/or increase a reliability of such testing when compared to a conventional probe system that does not measure and/or maintain the contact force between the probe and the DUT. This ability to maintain the constant contact force may be especially beneficial for tests of a relatively longer duration and/or for tests that are performed at a variety of different temperatures.

As another example, and as discussed, probe support 200 may be configured to detect deformation of elongate support body 210 during lateral motion of the probe relative to the DUT, such as may be indicative of the undesired contact, or physical contact, between at least one component of probe assembly 100 and other object 70 during the lateral motion. In such a configuration, motion control assembly 50 may be configured to cease the lateral motion between the probe assembly and the support surface responsive to the deformation output being indicative of the undesired contact. Such a configuration may decrease a potential for damage to probe assembly 100 and/or object 70 that might otherwise be caused by the undesired contact.

Returning to FIG. 1, probe systems 10 may include an optical assembly 60. Optical assembly 60 may be configured to collect an optical image of at least one component of probe assembly 100, such as probe 122, probe support 200, and/or DUT 32. In some examples, optical assembly 60 may be utilized to establish rough alignment between probe 122 and DUT 32 and/or may be utilized to align the probe with the DUT within a plane that is parallel, or at least substantially parallel, to support surface 22. Subsequently, deformation output 250 may be utilized to establish, quantify, verify, and/or determine contact between the probe and the DUT and/or overdrive between the probe and the DUT. Examples of optical assembly 60 include a camera, a digital camera, a digital video camera, a light source, a charge coupled device, an electron-multiplying charge-coupled device, and/or a complementary metal-oxide semiconductor device.

With continued specific reference to FIG. 1 and general reference to FIGS. 2-3, probe assemblies 100 may include any suitable structure that includes probe support mounting structure 110, probe 122, and probe support 200. In some examples, probe 122 may include and/or be a needle probe 124 and/or an engineering probe. In some such examples, probe support mounting structure 110 may include and/or be a manipulator 114, which may be configured to operatively translate probe 122 relative to support surface 22 and/or relative to DUT 32, such as via operative translation of probe support 200. In some examples, probe assembly 100 may include a probe card 120 that includes probe 122, or even a plurality of probes 122. In some such examples, probe card 120 may be operatively attached to probe mount 214 of elongate support body 210. In some examples, probe support mounting structure 110 may include and/or be a platen 112.

As illustrated in dashed lines in FIG. 1, probe systems 10 and/or probe assemblies 100 thereof may include measurement electronics 140. As an example, probe systems 10 and/or probe assemblies 100 may include a voltage measurement device 142, which may be configured to measure and/or to quantify the deformation output voltage differential of deformation output 250. In some such examples, probe systems 10 and/or probe assemblies 100 may include an amplifier 144, which may be configured to receive deformation output 250 and/or to amplify the deformation output, such as to produce and/or generate an amplified deformation output. In such a configuration, voltage measurement device 142 may be configured to measure and/or to quantify an amplified deformation output voltage differential of the amplified deformation output. Additionally or alternatively, and in some such examples, probe systems 10 and/or probe assemblies 100 may include a digitizer 146, which may be configured to generate a digitized deformation output that is indicative of the deformation output. Motion control assembly 50 may receive deformation output 250 as the deformation output voltage differential, as the amplified deformation output, and/or as the digitized deformation output.

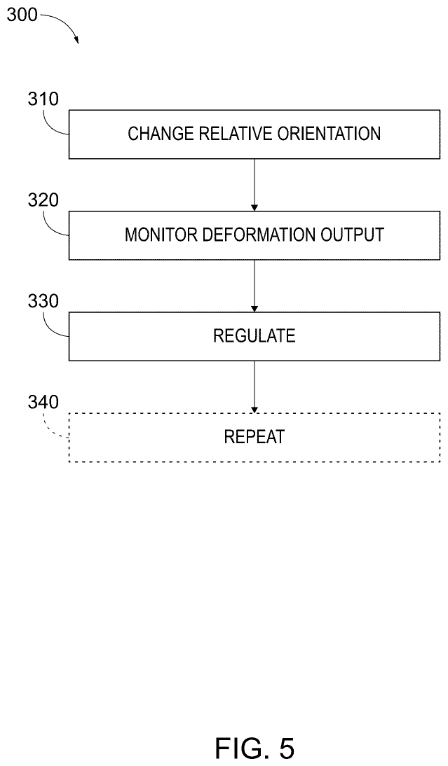

FIG. 5 is a flowchart illustrating examples of methods 300 of controlling operation of a probe system, according to the present disclosure. Examples of the probe system and/or components thereof are disclosed herein with reference to probe system 10. Methods 300 include changing a relative orientation at 310 and monitoring a deformation output at 320. Methods 300 also include regulating at 330 and may include repeating at 340.

Changing the relative orientation at 310 may include changing the relative orientation between a support surface of the probe system and a probe assembly of the probe system. In some examples, the changing at 310 may include moving a probe of the probe assembly toward a device under test (DUT) that is supported by the support surface and/or that is formed on a substrate that is supported by the support surface. In some examples, the changing at 310 may include moving the DUT toward the probe, such as via moving the support surface. In some examples, the changing at 310 may include laterally moving the probe relative to the support surface. In some examples, the changing at 310 may include laterally moving the support surface relative to the probe. In some examples, the changing at 310 may be performed utilizing a motion control assembly of the probe system. Examples of the support surface, the probe system, the probe assembly, the probe, the DUT, the substrate, and the motion control assembly are disclosed herein with reference to support surface 22, probe system 10, probe assembly 100, probe 122, DUT 32, substrate 30, and motion control assembly 50, respectively.

Monitoring the deformation output at 320 may include monitoring a deformation output of a deformation measurement structure of the probe system and may be performed during and/or concurrently with the changing at 310. The deformation output may be indicative of deformation of an elongate support body of the probe system that is operatively attached to the probe of the probe system. Examples of the deformation output, the deformation measurement structure, and the elongate support body are disclosed herein with reference to deformation output 250, deformation measurement structure 240, and elongate support body 210, respectively.

Regulating at 330 may include regulating the changing at 310 based, at least in part, on the deformation output. The regulating at 330 may be performed in any suitable manner. As an example, and when the changing at 310 includes moving the probe toward the DUT and/or moving the DUT toward the probe, the regulating at 330 may include detecting physical contact between the probe and the DUT. The detecting may be responsive to and/or based upon a change in the deformation output that is greater than a threshold deformation output change and/or a change in a slope of the deformation output as a function of position of the probe, as discussed herein with reference to FIG. 4. In such a configuration, the regulating at 330 further may include establishing a desired overdrive magnitude between the probe and the DUT based, at least in part, on the deformation output. This may include overdriving the probe and the DUT toward one another to establish a target deformation output, which corresponds to the desired overdrive magnitude and/or to a desired contact force between the probe and the DUT, and/or maintaining the target deformation output during subsequent testing of the DUT by the probe system. Examples of the threshold deformation output change, the slope of the deformation output as the function of position of the probe, and the overdrive are disclosed herein with reference to threshold deformation output contact change 294, slopes 296 and 298, and overdrive 299, respectively.

As another example, and when the changing at 310 includes laterally moving the probe relative to the support surface, the regulating at 330 may include ceasing the changing at 310 responsive to a change in the deformation output, during the laterally moving, that is greater than a threshold deformation output lateral change. As an example, and during the laterally moving, the probe assembly may inadvertently contact an object, which may cause a change in the deformation output. As such, the regulating at 330 may be utilized to avoid, or decrease a potential for, damage to the probe assembly and/or to the object due to the contact between the probe assembly and the object. Examples of the object are disclosed herein with reference to object 70.

Repeating at 340 may include repeating any suitable step and/or steps of methods 300 in any suitable manner. As an example, and subsequent to the regulating at 330 being utilized to detect physical contact between the probe and the DUT and/or to establish the desired overdrive magnitude between the probe and the DUT, methods 300 further may include electrically testing the DUT, such as via utilizing a signal generation an analysis assembly of the DUT, providing an electric test signal to the DUT, and/or receiving an electric resultant signal from the DUT. In such a configuration, and subsequent to the electrically testing, the repeating at 340 may include repeating the changing at 310, the monitoring at 320, and the regulating at 330 to detect physical contact and/or to establish the desired overdrive with another, or a second, DUT of a plurality of DUTs formed on the substrate and/or with a different contact pad of the DUT. Examples of the signal generation and analysis assembly, the electric test signal, and the electric resultant signal are disclosed herein with reference to signal generation and analysis assembly 40, electric test signal 42, and electric resultant signal 44, respectively.

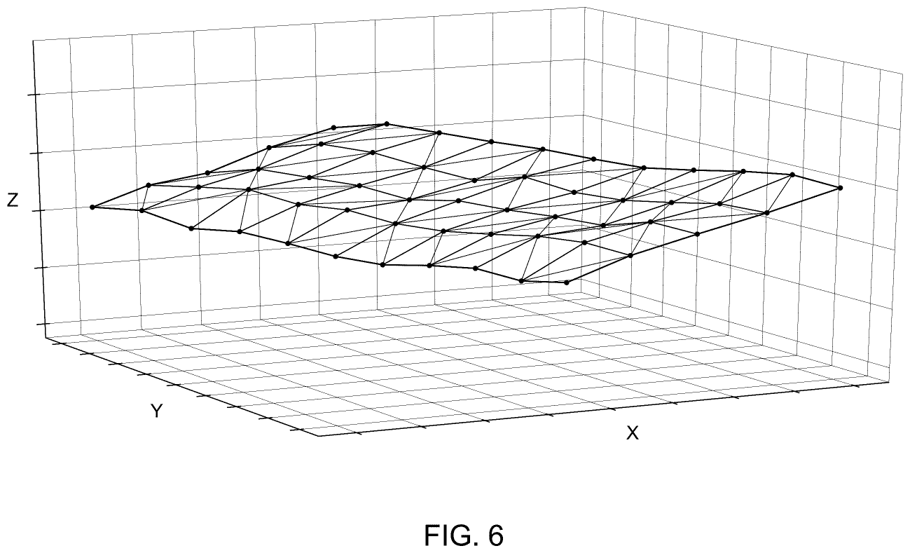

As another example, the regulating at 330 further may include determining a contact height at which the detecting physical contact occurs for a given DUT and/or for a given location on the surface of the substate. In such examples, the repeating at 340 may include repeating the changing at 310, the monitoring at 320, and the regulating at 330 at a plurality of spaced-apart locations on a surface, or an upper surface, of the substrate. As such, the repeating at 340 may be utilized to map a surface height of the substrate as a function of position on the substrate, as illustrated in FIG. 6. This map of surface height then may be utilized, such as during subsequent testing of one or more DUTs, to predict and/or to estimate when contact between the probe and the substrate will occur and/or to predict and/or estimate overdrive magnitude between the probe and the substrate. Such a configuration may permit and/or facilitate testing of all desired DUTs on the substrate, or even testing of all DUTs on the substrate, without requiring that the monitoring at 320 and/or regulating at 330 be performed for each DUT that is tested.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of probe supports, probe assemblies, probe systems, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.
A1. A probe support for a probe assembly of a probe system, the probe support comprising:
an elongate support body that extends between a support mount, which is configured to operatively attach the probe support to a remainder of the probe system, and a probe mount, which is configured to operatively attach a probe to the elongate support body; and
a deformation measurement structure configured to generate a deformation output indicative of deformation of the elongate support body.
A2. The probe support of paragraph A1, wherein the elongate support body defines a support body aspect ratio of at least one of:
(i) at least 4:1, at least 6:1, at least 8:1, at least 10:1, or at least 12:1; and
(ii) at most 30:1, at most 25:1, at most 20:1, at most 15:1, or at most 10:1.
A3. The probe support of paragraph A2, wherein the support body aspect ratio is a ratio of a longitudinal length of the elongate support body to a maximum transverse dimension of the elongate support body.
A4. The probe support of any of paragraphs A1-A3, wherein the elongate support body is at least one of rectangular, at least substantially rectangular, at least partially rectangular, a rectangular solid, an at least substantially rectangular solid, and an at least partial rectangular solid.
A5. The probe support of any of paragraphs A1-A4, wherein the elongate support body defines an elongate opening that extends at least partially between the support mount and the probe mount.
A6. The probe support of paragraph A5, wherein the elongate support body defines a support body length, and further wherein the elongate opening extends along a threshold opening fraction of the support body length, optionally wherein the threshold opening fraction is at least one of:
(i) at least 10%, at least 20%, at least 30%, at least 40%, at least 50%, at least 60%, at least 70%, or at least 80%; and
(ii) at most 90%, at most 80%, at most 70%, at most 60%, at most 50%, or at most 40%.
A7. The probe support of any of paragraphs A5-A6, wherein the elongate opening at least one of:
(i) is a rectangular, or at least partially rectangular, elongate opening; and
(ii) includes cylindrical, or at least partially cylindrical, opening end regions.
A8. The probe support of any of paragraphs A5-A7, wherein the elongate opening is at least one of polygonal, at least partially polygonal, ovoid, at least partially ovoid, trapezoidal, at least partially trapezoidal, squircular, and/or at least partially squircular.
A9. The probe support of any of paragraphs A5-A8, wherein the elongate support body defines a pair of opposed side body surfaces, and further wherein the elongate opening extends at least partially, or even completely, between the pair of opposed side body surfaces.
A10. The probe support of any of paragraphs A1-A9, wherein the support mount includes at least one of a support mount fastener, a support mount fastener-receiving region, and a support mount fastener-engaging region.
A11. The probe support of any of paragraphs A1-A10, wherein the probe mount includes at least one of a probe mount fastener, a probe mount fastener-receiving region, and a probe mount fastener-engaging region.
A12. The probe support of any of paragraphs A1-A11, wherein the deformation measurement structure is at least one of:
(i) operatively attached to the elongate support body; and
(ii) in mechanical communication with the elongate support body.
A13. The probe support of any of paragraphs A1-A12, wherein at least one of the deformation measurement structure and a plurality of deformation measurement sensors of the deformation measurement structure includes, or is, at least one of a strain gauge, a ring gauge, a force sensor, and a piezoelectric sensor.
A14. The probe support of any of paragraphs A1-A13, wherein the elongate support body and the deformation measurement structure together define a load cell.
A15. The probe support of any of paragraphs A1-A14, wherein the deformation measurement structure includes a/the plurality of deformation measurement sensors.
A16. The probe support of paragraph A15, wherein the plurality of deformation measurement sensors includes a plurality of identical, or at least substantially identical, deformation measurement sensors.
A17. The probe support of any of paragraphs A15-A16, wherein the plurality of deformation measurement sensors defines a bridge circuit.
A18. The probe support of any of paragraphs A1-A17, wherein the deformation of the elongate support body is responsive to physical contact between the probe and a device under test.
A19. The probe support of any of paragraphs A1-A18, wherein the elongate support body defines an upper body surface and an opposed lower body surface.
A20. The probe support of paragraph A19, wherein at least one of:
(i) the deformation measurement structure is operatively attached to the upper body surface;
(ii) the deformation measurement structure is operatively attached to the lower body surface;
(iii) the deformation measurement structure is in mechanical communication with the upper body surface;
(iv) the deformation measurement structure is in mechanical communication with the lower body surface;
(v) the deformation output is indicative of deformation of the upper body surface; and
(vi) the deformation output is indicative of deformation of the lower body surface.
A21. The probe support of any of paragraphs A19-A20, wherein the deformation measurement structure includes:
(i) a pair of upper deformation measurement sensors operatively attached to the upper body surface; and
(ii) a pair of lower deformation measurement sensors operatively attached to the lower body surface.
A22. The probe support of paragraph A21, wherein the pair of upper deformation measurement sensors includes a first upper deformation measurement sensor, which includes a first upper input and a first upper output, and a second upper deformation measurement sensor, which includes a second upper input and a second upper output, wherein the pair of lower deformation measurement sensors includes a first lower deformation measurement sensor, which includes a first lower input and a first lower output, and a second lower deformation measurement sensor, which includes a second lower input and a second lower output.
A23. The probe support of paragraph A22, wherein:
(i) the first upper input is electrically shorted to the first lower input to define a first input terminal;
(ii) the second upper input is electrically shorted to the second lower input to define a second input terminal;
(iii) the first upper output is electrically shorted to the second lower output to define a first output terminal; and
(iv) the second upper output is electrically shorted to the first lower output to define a second output terminal.
A24. The probe support of paragraph A23, where:
(i) the deformation measurement structure further includes an excitation voltage source that applies an excitation voltage differential between the first input terminal and the second input terminal; and
(ii) the deformation output is a deformation output voltage differential between the first output terminal and the second output terminal.
A25. The probe support of any of paragraphs A1-A24, wherein the deformation of the elongate support body is responsive to physical contact between the elongate support body and another object during lateral motion of the probe assembly.
A26. The probe support of any of paragraphs A1-A25, wherein the elongate support body includes a/the pair of opposed side body surfaces.
A27. The probe support of paragraph A26, wherein at least one of:
(i) the deformation measurement structure is operatively attached to at least one, and optionally both, of the pair of opposed side body surfaces;
(ii) the deformation measurement structure is in mechanical communication with at least one, and optionally both, of the pair of opposed side body surfaces; and
(iii) the deformation output is indicative of deformation of at least one, and optionally both, of the pair of opposed side body surfaces.
A28. The probe support of any of paragraphs A26-A27, wherein the deformation measurement structure includes:
(i) a first pair of lateral deformation measurement sensors operatively attached to a first side body surface of the pair of opposed side body surfaces; and
(ii) a second pair of lateral deformation measurement sensors operatively attached to a second side body surface of the pair of opposed side body surfaces.
B1. A probe assembly for a probe system, the probe assembly comprising:
the probe support of any of paragraphs A1-A28;
a probe support mounting structure operatively attached to the support mount; and a probe operatively attached to the probe mount.
B2. The probe assembly of paragraph B1, wherein the probe includes, or is, at least one of a needle probe and an engineering probe.
B3. The probe assembly of any of paragraphs B1-B2, wherein the probe support mounting structure includes, or is, a manipulator configured to operatively translate the probe relative to a/the device under test.
B4. The probe assembly of any of paragraphs B1-B3, wherein the probe assembly further includes a probe card that includes the probe, wherein the probe card is operatively attached to the probe mount.
B5. The probe assembly of any of paragraphs B1-B4, wherein the probe support mounting structure includes, or is, a platen.
B6. The probe assembly of any of paragraphs B1-B5, wherein the probe assembly further includes an excitation voltage source configured to provide an excitation voltage differential to the deformation measurement structure.
B7. The probe assembly of any of paragraphs B1-B6, wherein the probe assembly further includes a voltage measurement device configured to quantify a deformation output voltage differential of the deformation output.
B8. The probe assembly of paragraph B7, wherein the probe assembly further includes an amplifier configured to receive the deformation output and to amplify the deformation output to generate an amplified deformation output, and further wherein the voltage measurement device is configured to quantify an amplified deformation output voltage differential of the amplified deformation output.
B9. The probe assembly of any of paragraphs B1-B8, wherein the probe assembly further includes a digitizer configured to generate a digitized deformation output that is indicative of the deformation output.
C1. A probe system, comprising:
a chuck that defines a support surface configured to support a substrate that includes a/the device under test (DUT);
the probe assembly of any of paragraphs B1-B9 positioned to permit the probe to selectively contact the DUT; and
a signal generation and analysis assembly configured to at least one of provide an electric test signal to the DUT via the probe and receive an electric resultant signal from the DUT via the probe.
C2. The probe system of paragraph C1, wherein the probe system further includes a motion control assembly configured to selectively regulate a relative orientation between the support surface and the probe assembly to facilitate contact between the probe and the DUT.
C3. The probe system of paragraph C2, wherein the motion control assembly is configured to receive the deformation output from the probe assembly and to selectively regulate relative motion between the support surface and the probe assembly based, at least in part, on the deformation output.
C4. The probe system of paragraph C3, wherein the motion control assembly is configured to regulate overdrive between the probe and the DUT based, at least in part, on the deformation output.
C5. The probe system of any of paragraphs C3-C4, wherein the motion control assembly is configured to cease lateral motion between the probe assembly and the support surface responsive to the deformation output being indicative of physical contact between the elongate support body and another object during the lateral motion.
C6. The probe system of any of paragraphs C1-C5, wherein the probe system further includes an optical assembly configured to collect an optical image of at least one of the probe and the DUT.
D1. A method of controlling the operation of a probe system, the method comprising:
changing a relative orientation between a support surface of the probe system and a probe assembly of the probe system;
during the changing, monitoring a deformation output of a deformation measurement structure of the probe system, wherein the deformation output is indicative of deformation of an elongate support body that is operatively attached to a probe of the probe system; and
regulating the changing based, at least in part, on the deformation output.
D2. The method of paragraph D1, wherein the changing the relative orientation includes moving the probe toward a DUT defined on a substrate that is supported by the support surface, and further wherein the regulating includes detecting physical contact between the probe and the DUT responsive to a change in the deformation output that is greater than a threshold deformation output contact change.
D3. The method of paragraph D2, wherein the regulating further includes establishing a desired overdrive magnitude between the probe and the DUT based, at least in part, on the deformation output.
D4. The method of any of paragraphs D1-D3, wherein the changing the relative orientation includes laterally moving the probe relative to the support surface, and further wherein the regulating includes ceasing the changing responsive to a change in the deformation output during the laterally moving that is greater than a threshold deformation output lateral change.
D5. The method of any of paragraphs D1-D4, wherein the probe system includes any suitable structure, function, and/or feature of any of the probe supports of any of paragraphs A1-A28, any of the probe assemblies of any of paragraphs B1-B9, and/or any of the probe systems of any of paragraphs C1-C6.

### INDUSTRIAL APPLICABILITY

The probe supports, probe assemblies, probe systems, and methods disclosed herein are applicable to the semiconductor manufacturing and test industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A probe assembly for a probe system, the probe assembly comprising:
a probe support that includes:
(i) an elongate support body that extends between a support mount and a probe mount; and
(ii) a deformation measurement structure configured to generate a deformation output indicative of deformation of the elongate support body;
a probe support mounting structure operatively attached to the support mount; and
a probe operatively attached to the probe mount.

2. The probe assembly of claim 1, wherein the elongate support body defines a support body aspect ratio of at least 4:1 and at most 30:1.

3. The probe assembly of claim 1, wherein the elongate support body defines an elongate opening that extends at least partially between the support mount and the probe mount.

4. The probe assembly of claim 3, wherein the elongate support body defines a support body length, and further wherein the elongate opening extends along at least 10% and at most 90% of the support body length.

5. The probe assembly of claim 3, wherein the elongate support body defines a pair of opposed side body surfaces, and further wherein the elongate opening extends at least partially between the pair of opposed side body surfaces.

6. The probe assembly of claim 1, wherein the deformation measurement structure includes at least one of a strain gauge, a ring gauge, a force sensor, and a piezoelectric sensor.

7. The probe assembly of claim 1, wherein the deformation measurement structure includes a plurality of deformation measurement sensors.

8. The probe assembly of claim 7, wherein the plurality of deformation measurement sensors includes a plurality of at least substantially identical deformation measurement sensors.

9. The probe assembly of claim 7, wherein the plurality of deformation measurement sensors defines a bridge circuit.

10. The probe assembly of claim 1, wherein the elongate support body defines an upper body surface and an opposed lower body surface, and further wherein at least one of:
(i) the deformation measurement structure is operatively attached to the upper body surface;
(ii) the deformation measurement structure is operatively attached to the lower body surface;
(iii) the deformation output is indicative of deformation of the upper body surface; and
(iv) the deformation output is indicative of deformation of the lower body surface.

11. The probe assembly of claim 1, wherein the elongate support body defines an upper body surface and an opposed lower body surface, and further wherein the deformation measurement structure includes:
(i) a pair of upper deformation measurement sensors operatively attached to the upper body surface; and
(ii) a pair of lower deformation measurement sensors operatively attached to the lower body surface.

12. The probe assembly of claim 11, wherein the pair of upper deformation measurement sensors includes a first upper deformation measurement sensor, which includes a first upper input and a first upper output, and a second upper deformation measurement sensor, which includes a second upper input and a second upper output, wherein the pair of lower deformation measurement sensors includes a first lower deformation measurement sensor, which includes a first lower input and a first lower output, and a second lower deformation measurement sensor, which includes a second lower input and a second lower output.

13. The probe assembly of claim 12, wherein:
(i) the first upper input is electrically shorted to the first lower input to define a first input terminal;
(ii) the second upper input is electrically shorted to the second lower input to define a second input terminal;
(iii) the first upper output is electrically shorted to the second lower output to define a first output terminal; and
(iv) the second upper output is electrically shorted to the first lower output to define a second output terminal.

14. The probe assembly of claim 13, wherein:
(i) the deformation measurement structure further includes an excitation voltage source that applies an excitation voltage differential between the first input terminal and the second input terminal; and
(ii) the deformation output is a deformation output voltage differential between the first output terminal and the second output terminal.

15. The probe assembly of claim 1, wherein the elongate support body includes a pair of opposed side body surfaces, and further wherein at least one of:
(i) the deformation measurement structure is operatively attached to at least one of the pair of opposed side body surfaces;
(ii) the deformation measurement structure is in mechanical communication with at least one of the pair of opposed side body surfaces; and
(iii) the deformation output is indicative of deformation of at least one of the pair of opposed side body surfaces.

16. The probe assembly of claim 1, wherein the probe assembly further includes an excitation voltage source configured to provide an excitation voltage differential to the deformation measurement structure, and further wherein the probe assembly includes a voltage measurement device configured to quantify a deformation output voltage differential of the deformation output.

17. A probe system, comprising:
a chuck that defines a support surface configured to support a substrate that includes a device under test (DUT);
the probe assembly of claim 1 positioned to permit the probe to selectively contact the DUT; and
a signal generation and analysis assembly configured to at least one of provide an electric test signal to the DUT via the probe and receive an electric resultant signal from the DUT via the probe.

18. The probe system of claim 17, wherein the probe system further includes a motion control assembly configured to selectively regulate a relative orientation between the support surface and the probe assembly to facilitate contact between the probe and the DUT.

19. The probe system of claim 18, wherein the motion control assembly is configured to receive the deformation output from the probe assembly and to selectively regulate relative motion between the support surface and the probe assembly based, at least in part, on the deformation output.

20. A method of controlling the operation of a probe system, the method comprising:
changing a relative orientation between a support surface of the probe system and a probe assembly of the probe system;
during the changing, monitoring a deformation output of a deformation measurement structure of the probe system, wherein the deformation output is indicative of deformation of an elongate support body that is operatively attached to a probe of the probe system; and
regulating the changing based, at least in part, on the deformation output.
